(19) United States
(12) Patent Application Publication
(10) Pub. No.: US 2007/0162554 A1
(43) Pub. Date: Jul. 12, 2007

(54) Generating a public key and a private key in an instant messaging server

(75) Inventors: Steven Joseph Branda, Rochester, MN (US); John Joseph Stecher, Rochester, MN (US)

Correspondence Address: WOOD, HERRON & EVANS, L.L.P. (IBM), 2700 CAREW TOWER, 441 VINE STREET, CINCINNATI, OH, 45202, US

(73) Assignee: International Business Machines Corporation, Armonk, NY (US)

(21) Appl. No.: 11/330,690

(22) Filed: Jan. 12, 2006

(51) Int. Cl. G06F 15/16

(52) U.S. Cl. 709/207

(57) ABSTRACT

An apparatus, program product and method generate a public key and a private key in an instant messaging server. The public key and the private key may be generated in the instant messaging server in connection with the user logging into the instant messaging server. As such, the public key and the private key may be used to encrypt and/or decrypt instant messages in connection with peer to peer instant messaging.

### FIELD OF THE INVENTION

The invention relates to computers and computer systems, and in particular, generating a public key and a private key in an instant messaging server.

### BACKGROUND OF THE INVENTION

The Internet has profoundly changed many aspects of contemporary society, and has become an increasingly important resource for numerous educational, entertainment and commercial purposes. The Internet generally facilitates information exchange between users, thus, e-mailing and instant messaging have become popular forms of communication, both for personal and business use.

In particular, instant messaging systems typically permit users, whom are logged into the same instant messaging system, to send and receive instant messages to and from each other in realtime. An instant message, which may also be referred to as a chat message, is generally a communication sent by one user to one or more other users. An instant messaging system generally handles the exchange of instant messages, and typically supports the ability to display an instant messaging window incorporating a running transcript of the ongoing chat between the participating users on each user's computer screen.

Instant messaging systems are typically implemented via a client-server environment or a peer to peer environment. In the former, each user may login to an instant messaging server via their instant messaging client and the instant messaging server generally functions as an intermediary and passes instant messages between the users. The peer to peer environment may also include an instant messaging server for user login as well as a central user database. In the peer to peer environment, the instant messaging server initially functions as an intermediary and then the instant messages may be transmitted directly between the users via their instant messaging clients.

The peer to peer environment is generally more scalable than the client-server implementation. In particular, the peer to peer environment generally facilitates instant messaging by a large number of users with less of a strain on an instant messaging system. However, one problem that users may encounter when participating in a conversation via peer-to-peer instant messaging is security.

Typically, security for peer to peer instant messaging is implemented by a public and private key pair. A key may be any information used to identify a user. A key pair is typically generated when the user installs instant messaging software (i.e., instant messaging client) on his or her computer, and the public key of the key pair is generally used to encrypt the instant messages sent by the user. The security risk may arise when the key pair is not modified (i.e., stale). Generally, the longer the key pair remains unchanged on the user's computer, the more likely it may be that the key pair may be compromised and used to gain unauthorized access to confidential instant messages (e.g., malicious instant messaging client, packet sniffing applications, hostile applications such as viruses, etc).

In an effort to reduce key pairs from becoming stale, systems that manage key pairs may be used. Companies, for example, may require that every couple of weeks all their employees change their key pairs and may provide techniques to facilitate the key pair changes, which may require a separate key server. Additionally, a company may also have to track all the employees that have and have not changed their key pair to ensure that all the employees change their key pairs. However, despite the management of the key pairs, burden on users, and wasted resources, some key pairs may still become stale and pose a security risk.

Additionally, security for peer to peer instant messaging has been implemented by a single key, perhaps in combination with a key pair, by verifying that the single key exchanged via a peer to peer connection is similar to the single key exchanged over an instant messaging server. However, this too poses a security risk. First, because the single key is continuously passed between the user computers and the server, and there is only one key between the users, the single key may become compromised through this transmittal. Additionally, the overhead on the instant messaging server may be high as the single key is sent across the instant messaging server for each instant message, which may hinder scalability.

A need therefore exists in improving peer to peer instant messaging, in particular, an improved manner of securely communicating via peer to peer instant messaging that promotes scalability but reduces the burden on users of ensuring that key pairs do not become stale.

### SUMMARY OF THE INVENTION

The invention addresses these and other problems associated with the prior art by providing an apparatus, program product and method that generate a public key and a private key in an instant messaging server for a user. In particular, embodiments consistent with the invention may generate the public key and the private key in the instant messaging server for a first user in connection with a first user logging into the instant messaging server. Additionally, the public key may be sent to a second user that wants to communicate via peer to peer instant messaging with the first user. A different public and/or private key may be generated for the first user each time he or she logs into the instant messaging server. By doing so, instant messages may be encrypted and/or decrypted with public and private key pairs that are changed more frequently, thus, reducing the time period when the public and/or private keys may become comprised. Furthermore, as the public and private key may be automatically generated in the instant messaging server, the need for management of key pairs and burden on users may also be reduced.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 is a block diagram of a client-server implementation portion of an instant messaging system consistent with the invention.

FIG. 2 is a block diagram of a peer to peer implementation portion of an instant messaging system consistent with the invention.

FIG. 3 is a flowchart of a peer to peer instant messaging routine executed by an instant messaging system of FIGS. 1 and 2.

### DETAILED DESCRIPTION

The embodiments discussed hereinafter generate a public key and a private key in an instant messaging server for at least one user for communicating via peer to peer instant messaging. A public key and a private key may be any data used to identify a user with whom the public key and/or the private key are associated with. A public key and a private key different than a previous public key and/or private key may be generated in the instant messaging server in connection with a user logging into the instant messaging server. A public key and/or a private key may be used to encrypt and/or decrypt instant messages. Furthermore, the public key and/or the private key of a user may only be valid for the current login session, and the public key and/or private key of the user may be invalidated in connection with the user logging out of the instant messaging server.

Consistent with the invention, the term “instant message” may be at least a portion of a communication sent and/or received or capable of being sent and/or received by at least one user via an instant messaging system. Those of ordinary skill in the art may appreciate from the discussion hereinbelow that an instant message may refer to one or more than one instant message. Similarly, the term “chat” may also be at least a portion of one communication or more than one communication sent and/or received, or capable of being sent and/or received, by at least one user via an instant messaging system. The term “chat” may also refer to the receiving and/or sending of at least one communication or ability to send and/or receive at least one communication by two users as well as by more than two users. Likewise, the term “instant messaging” and “chatting” generally refers to sending and/or receiving a communication or ability to send and/or receive a communication. The terms “instant message”, “chat”, “instant messaging” and “chatting” are used interchangeably herein as they all generally refer to sending and/or receiving a communication. However, those of ordinary skill in the art should appreciate that by using them interchangeably the scope of none of the terms should be limited.

Additionally, the term “instant messaging system” relates to the sending and/or receiving of an instant message as well as the structure, features and functionality that may be associated with sending and/or receiving an instant message. Moreover, the term “peer to peer instant messaging” relates to the sending and/or receiving of an instant message practically directly from one user to another user, although an intermediary (e.g., instant messaging server) may be used for a portion of the sending and/or receiving.

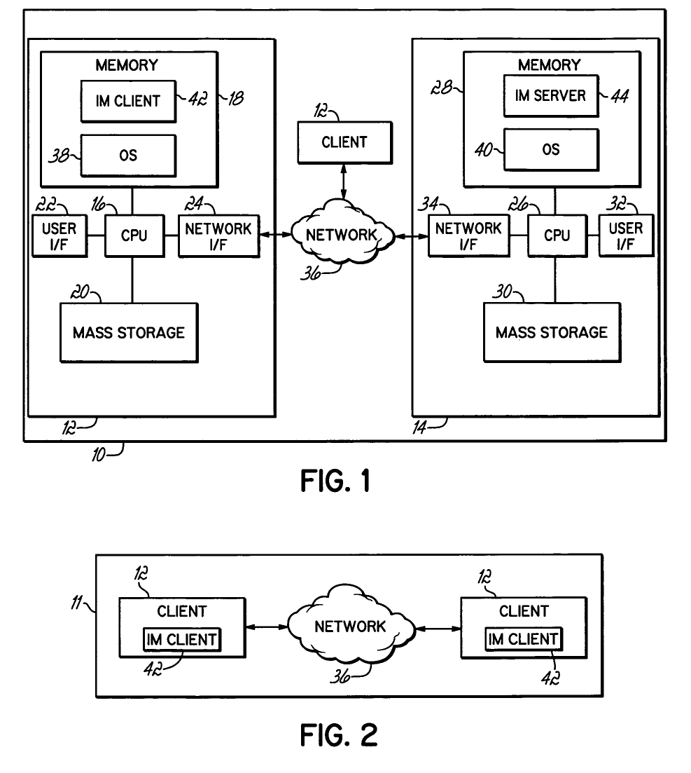

Turning now to the Drawings, wherein like numbers denote like parts throughout the several views, an instant messaging system consistent with the invention may be a combination of a client-server environment 10 illustrated in FIG. 1 and a peer to peer environment 11 illustrated in FIG. 2. Referring to FIG. 1, the client-server computer system 10 may be part of an instant messaging system with the client computers 12 as instant messaging clients and the server computers 14 as instant messaging servers. System 10 includes at least one apparatus, e.g., one or more client computers 12 and one or more server computers 14. For the purposes of the invention, each computer 12, 14 may represent practically any type of computer, computer system or other programmable electronic device capable of functioning as a client and/or server in a client-server environment. Moreover, each computer 12, 14 may be implemented using one or more networked computers, e.g., in a cluster or other distributed computing system. Moreover, as is common in many client-server systems, typically multiple client computers 12 will be interfaced with a given server computer 14.

Computer 12 typically includes a central processing unit 16 including at least one microprocessor coupled to a memory 18, which may represent the random access memory (RAM) devices comprising the main storage of computer 12, as well as any supplemental levels of memory, e.g., cache memories, non-volatile or backup memories (e.g., programmable or flash memories), read-only memories, etc. In addition, memory 18 may be considered to include memory storage physically located elsewhere in computer 12, e.g., any cache memory in a processor in CPU 16, as well as any storage capacity used as a virtual memory, e.g., as stored on a mass storage device 20 or on another computer coupled to computer 12. Computer 12 also typically receives a number of inputs and outputs for communicating information externally. For interface with a user or operator, computer 12 typically includes a user interface 22 incorporating one or more user input devices (e.g., a keyboard, a mouse, a trackball, a joystick, a touchpad, and/or a microphone, among others) and a display (e.g., a CRT monitor, an LCD display panel, and/or a speaker, among others). Otherwise, user input may be received via another computer or terminal.

For additional storage, computer 12 may also include one or more mass storage devices 20, e.g., a floppy or other removable disk drive, a hard disk drive, a direct access storage device (DASD), an optical drive (e.g., a CD drive, a DVD drive, etc.), and/or a tape drive, among others. Furthermore, computer 12 may include an interface 24 with one or more networks (e.g., a LAN, a WAN, a wireless network, and/or the Internet, among others) to permit the communication of information with other computers and electronic devices. It should be appreciated that computer 12 typically includes suitable analog and/or digital interfaces between CPU 16 and each of components 18, 20, 22 and 24 as is well known in the art.

In a similar manner to computer 12, computer 14 includes a CPU 26, memory 28, mass storage 30, user interface 32 and network interface 34. However, given the nature of computers 12 and 14 as client and server, in many instances computer 14 will be implemented using a multi-user computer such as a server computer, a midrange computer, a mainframe, etc., while computer 12 will be implemented using a desktop or other single-user computer. As a result, the specifications of the CPU's, memories, mass storage, user interfaces and network interfaces will typically vary between computers 12 and 14. Other hardware environments are contemplated within the context of the invention.

Computers 12, 14 are generally interfaced with one another via a network 36, which may be public and/or private, wired and/or wireless, local and/or wide-area, etc. Moreover, network 36 may represent multiple, interconnected networks. In the illustrated embodiment, for example, network 36 may include the Internet.

Each computer 12, 14 operates under the control of an operating system 38, 40, and executes or otherwise relies upon various computer software applications, components, programs, objects, modules, data structures, etc. (e.g. instant messaging (IM) client 42 and instant messaging (IM) server 44). Moreover, various applications, components, programs, objects, modules, etc. may also execute on one or more processors in another computer coupled to computer 12, 14 via a network, e.g., in a distributed or client-server computing environment, whereby the processing required to implement the functions of a computer program may be allocated to multiple computers over a network.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution. Examples of computer readable media include but are not limited to tangible recordable type media such as volatile and non-volatile memory devices, floppy and other removable disks, hard disk drives, magnetic tape, optical disks (e.g., CD-ROMs, DVDs, etc.), among others, and transmission type media such as digital and analog communication links.

In addition, various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

FIG. 2 generally illustrates a peer to peer based computer system or environment 11 that may be used consistent with the invention. In particular, the peer to peer computer system 11 may be part of the instant messaging system with one or more peer computers 15 interfacing with one another via a network 36, which may be public and/or private, wired and/or wireless, local and/or wide-area, etc. Moreover, network 36 may represent multiple, interconnected networks. In the illustrated embodiment, for example, network 36 may include the Internet.

Each peer computer 15 may act as both a client 12 and a server 14 as generally described by like numbers in connection with FIG. 1. In particular, peer computer 15 may interface with a central server 14 of FIG. 1 for login, generation of public and private keys, and authentication. Afterwards, a peer computer 15 may engage in peer to peer instant messaging by interfacing directly with another peer computer 15, with the instant messages encrypted with the public key associated with the peer computers 15 receiving the instant message. Peer to peer instant messaging architectures are known to those of ordinary skill in the art and practically any peer to peer instant messaging architecture may be used consistent with the invention.

Those skilled in the art will recognize that the exemplary environments illustrated in FIGS. 1 and 2 are not intended to limit the present invention. Indeed, those skilled in the art will recognize that other alternative hardware and/or software environments may be used without departing from the scope of the invention.

As noted above, embodiments consistent with the invention are generally configured to generate a public key and a private key in the instant messaging server. In the context of the invention, an instant messaging server 44 may generally be considered to include any program code resident on a computer or other programmable electronic device that is capable of servicing such requests in a distributed computer system. It should also be appreciated that an instant messaging server 44 in this context may be resident on the same computer as the instant messaging client 42, (e.g., in the peer to peer system 11 described hereinabove), or in the alternative, the server 44 may be resident on an intermediate computer coupled between the client(s) (e.g., as illustrated in client-server system 10). In the context of the invention, an instant messaging client 42 may generally be considered to include any program code resident on a computer or other programmable electronic device that is capable of making requests of another computer in a distributed computer system. Additionally, instant messaging client 42 and instant messaging server 44 may be considered to include the hardware associated with each (e.g., client computer 12 and server computer 14, respectively) as well as the software (e.g., program code).

As mentioned above, an instant messaging system consistent with the invention may be a combination of a client-server environment 10 illustrated in FIG. 1 and a peer to peer environment 11 illustrated in FIG. 2. In particular, an instant messaging server 44 (e.g., server computer 14) may be used for central login, generation of public and private key pairs, and authentication. Furthermore, users may send and/or receive instant messages encrypted with public keys via their instant messaging clients 42 (e.g., peer computer 15 and/or client computer 12). As an example, one or more peer computers 15 may interface with an instant messaging server 44 for login, and instant messaging server 44 may generate a public key and a private key for each peer computer 15. Instant messaging server 44 may also be used to authenticate public keys, and after the authentication, a peer computer 15 may interface directly with another peer computer 15 as illustrated in peer to peer environment 11 to engage in peer to peer instant messaging, with instant messages encrypted with the public key of the peer computer 15 receiving the instant messages.

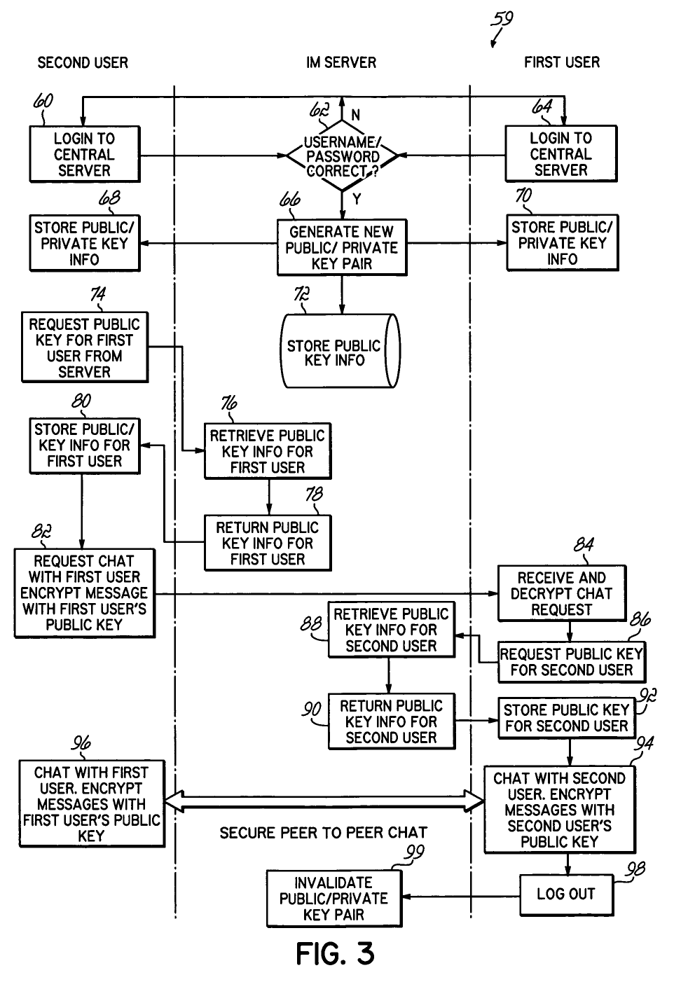

Turning to FIG. 3, which illustrates an exemplary peer to peer instant messaging routine 59 consistent with the invention. FIG. 3 generally illustrates the interaction between a first user, a second user, and a central server (i.e., instant messaging server). Initially, the first user and the second user interact with the central server, and afterwards, the first user and the second user interact directly or more directly. The two vertical lines generally demarcate the three entities, in particular, the functionality illustrated in the second user's column may be performed via the second user's instant messaging client, the functionality illustrated in the central server's column may be performed via the central server (i.e., instant messaging server), and the functionality illustrated in the first user's column may be performed via the first user's instant messaging client.

Turning to routine 59, in blocks 60 and 64, the second user and the first user, respectively, seek to login to the central server. The second user and the first user may login to the central server (e.g., a server 14 as described in FIG. 1) via their instant messaging clients 42. The second user and the first user may login at different times from different locations, etc. To login, the second user and the first user may type a predefined username and/or password using a keyboard. Alternatively, a user may place a file on his or her computer to automatically login to the central server instead of retyping user names and/or passwords each time the user wants to login to the server.

Next, block 62 determines if the username and/or password of the second user and/or first user are correct. If not, the user may not be able to login to the server and may be presented with an error message or an opportunity to retype the username and/or password. Once the username and/or password are authenticated and determined to be correct by the central server for a user, control passes to block 66 for the central server to generate a new public and private key pair for that user. Thus, if the second user's username and/or password were correct, then a new public and private key pair may be generated by the central server for the second user in block 66 and the public and private key pair information may be stored for the second user in block 68. Similarly, if the first user's username and/or password were correct, then a new public and private key pair may be generated by the central server for the first user in block 66 and the public and private key pair information may be stored for the first user in block 70. In particular, the public and/or private key pairs will be used to encrypt and/or decrypt instant messages received and/or sent by the second user and/or the first user. Additionally, any public keys generated by the central server may be stored in block 72 for later use by the central server.

The public key and the private key generated by the central server may be different than a previous public key and/or previous private key generated by the central server during a previous login of a user. In particular, a different public key and/or a private key may be generated each time a user logs into the central server.

Next, when the second user wants to communicate with the first user, the second user may request the public key of the first user from the central server in block 74. The central server may comply with the second user's request by retrieving the public key of the first user in block 76 and returning the public key of the first user to the second user in block 78. In addition to the public key of the first user, an IP address and/or a port associated with the first user may also be retrieved and returned by the central server to the second user. The public key of the first user, as well as an IP address and/or a port, may then be stored in block 80. Next, the second user may request to chat with the first user (e.g., send at least one instant message to the first user) in block 82. Thus, the instant message may be encrypted with the stored public key of the first user that the second user received from the central server. The chat request may be sent to the first user based upon the IP address of the first user and/or port associated with the first user. Additionally, the public key of the second user may also be sent to the first user with the chat request.

Next, in block 84, the first user may receive and decrypt the chat request from the second user. In decrypting the chat request, the first user may use his or her private key, which was stored in connection with block 70. Additionally, the public key of the second user that was transmitted to the first user may be authenticated with the central server. In particular, the first user may request the public key of the second user in block 86, and the public key of the second user may be retrieved by the central server in block 88 and returned to the first user in block 90. An IP address and/or a port associated with the second user may also be retrieved and returned by the central server to the first user in blocks 88 and 90, respectively. The public key of the second user, as well as an IP address and/or a port, may then be stored in block 92. Nonetheless, the public key of the second user returned by the central server may be used to authenticate the public key of the second user that may have been received in block 84.

After authentication, the instant message sent by the second user to the first user may be displayed for the first user (e.g., on the first user's computer screen) and the first user may respond to the instant message. Thus, the first user and the second user may continue to communicate with each other by sending instant messages that are encrypted with the second user's public key and/or the first user's public key depending on who is receiving the instant message. Turning to block 94, the first user can chat with the second user by sending at least one instant message that is encrypted with the second user's public key. Likewise, in block 96, the second user can chat with the first user by sending at least one instant message that is encrypted with the first user's public key. Thus, in this manner, the first user and the second user may engage in peer to peer instant messaging. Generally, any public key and private key encryption and/or decryption technique known to those of ordinary in the art may be used consistent with the invention.

When the first user logs out of the central server or is logged out (e.g., automatically logged out due to inactivity), his or her public key and/or private key may be invalidated (e.g., by the central server). Similarly, when the second user logs out of the central server or is logged out, his or her public key and/or private key may be invalidated. Therefore, the public key and/or private key generated by the central server may only be valid for the current login session with keys valid for a day or two.

Those of ordinary skill in the art may appreciate that the keys are changed more frequently consistent with the invention, thus, the risk that the keys will be compromised by an unauthorized user and/or application is reduced because the time period the keys are available is reduced. Furthermore, because each instant message is encrypted with the public key of the user receiving the instant message, the security risk of unauthorized access may be reduced.

Additionally, the strain on the central server may be minimal despite the functionality of login, authentication, and generation of public and private key pairs. Moreover, because the key pairs are generated in the central server (i.e., instant messaging server), the key pairs may be generated automatically and the burden on users to change their key pairs may be reduced. Furthermore, infrastructures may not need to be changed to practice embodiments consistent with the invention. Companies, for example, may not need to change their infrastructures nor waste time and resources to require its users to change their key pairs and track those changes. Thus, those of ordinary skill in the art may appreciate that this peer to peer instant messaging is generally more secure than peer to peer instant messaging performed by traditional methods.

Various modifications may be made to the illustrated embodiments without departing from the spirit and scope of the invention. Therefore, the invention lies in the claims hereinafter appended.

What is claimed is:

1. A method of communicating via peer to peer instant messaging, the method comprising:
(a) in an instant messaging server, generating a public key and a private key for a first user in connection with the first user logging into the instant messaging server; and
(b) in response to a second user request to communicate with the first user via peer to peer instant messaging, sending the public key of the first user to the second user.

2. The method of claim 1, further comprising generating a public key and a private key for the second user in connection with the second user logging into the instant messaging server.

3. The method of claim 2, further comprising using the public key of the second user to encrypt at least one instant message from the first user to the second user.

4. The method of claim 2, further comprising sending the public key of the second user to the first user.

5. The method of claim 2, further comprising authenticating the public key of the second user with the instant messaging server.

6. The method of claim 1, further comprising sending an instant message to the first user from the second user.

7. The method of claim 6, wherein sending the instant message includes using at least one of an IP address or port of the first user.

8. The method of claim 1, further comprising using the public key of the first user to encrypt at least one instant message from the second user to the first user.

9. The method of claim 1, wherein generating the public key and the private key includes generating at least one of the public key or the private key each time the first user logs into the instant messaging server.

10. The method of claim 1, wherein generating at least one of the private key or the public key for the first user includes generating a key that is different than a previous key generated by the instant messaging server for the first user in connection with the first user previously logging into the instant messaging server.

11. The method of claim 1, further comprising decrypting at least one instant message from the second user to the first user using the private key of the first user.

12. The method of claim 1, further comprising invalidating at least one of the public key or private key of the first user in connection with the first user logging off the instant messaging server.

13. An apparatus, comprising:
(a) a processor;
(b) a memory; and
(c) program code configured to communicate via peer to peer instant messaging by generating a public key and a private key in an instant messaging server for a first user in connection with the first user logging into the instant messaging server and in response to a second user request to communicate with the first user via peer to peer instant messaging, sending the public key of the first user to the second user.

14. The apparatus of claim 13, wherein the program code is further configured to generate a public key and a private key for the second user in connection with the second user logging into the instant messaging server.

15. The apparatus of claim 14, wherein the program code is further configured to use the public key of the second user to encrypt at least one instant message from the first user to the second user.

16. The apparatus of claim 14, wherein the program code is further configured to send the public key of the second user to the first user.

17. The apparatus of claim 14, wherein the program code is further configured to authenticate the public key of the second user with the instant messaging server.

18. The apparatus of claim 13, wherein the program code is further configured to send an instant message to the first user from the second user.

19. The apparatus of claim 18, wherein the program code is further configured to send the instant message by using at least one of an IP address or port of the first user.

20. The apparatus of claim 13, wherein the program code is further configured to use the public key of the first user to encrypt at least one instant message from the second user to the first user.

21. The apparatus of claim 13, wherein the program code is further configured to generate the public key and the private key by generating at least one of the public key or the private key each time the first user logs into the instant messaging server.

22. The apparatus of claim 13, wherein the program code is further configured to generate at least one of the private key or the public key for the first user by generating a key that is different than a previous key generated by the instant messaging server for the first user in connection with the first user previously logging into the instant messaging server.

23. The apparatus of claim 13, wherein the program code is further configured to decrypt at least one instant message from the second user to the first user using the private key of the first user.

24. The apparatus of claim 13, wherein the program code is further configured to invalidate at least one of the public key or private key of the first user in connection with the first user logging off the instant messaging server.

25. A program product, comprising:
(a) program code configured to communicate via peer to peer instant messaging by generating a public key and a private key in an instant messaging server for a first user in connection with the first user logging into the instant messaging server and in response to a second user request to communicate with the first user via peer to peer instant messaging, sending the public key of the first user to the second user; and
(b) a computer readable medium bearing the program code.
